(19) United States
(12) Patent Application Publication
(10) Pub. No.: US 2007/0027651 A1
(43) Pub. Date: Feb. 1, 2007

(54) System and method for a color sensor

(76) Inventors: Joh Joh Ng, Bagan Seral (MY); Chee Wai Chia, Penang (MY); Heng Yow Cheng, Penang (MY)

Correspondence Address: AVAGO TECHNOLOGIES, LTD., P.O. BOX 1920, DENVER, CO, 80201-1920, US

(21) Appl. No.: 11/190,329

(22) Filed: Jul. 27, 2005

(51) Int. Cl. G01C 25/00; H04N 17/00

(52) U.S. Cl. 702/116; 348/187

(57) ABSTRACT

In one embodiment of the invention there is disclosed a device for correcting the output of a light source such that the corrected output conforms to a known standard. The corrected light outputs are proportional to the colors contained in the light impacting the color sensor. In one embodiment, memory contains at least one color matching function pertaining to the specific color sensor and a controller works with the memory to convert the color sensor light outputs to a specific color PCS space based on the matching function. If desired, a user can select a desired PCS protocol.

### CROSS-REFERENCE TO RELATED APPLICATIONS

This application is related to currently pending U.S. patent application Ser. No. 11/029,613 entitled “COLOR MEASUREMENTS OF AMBIENT LIGHT”, the disclosure of which is hereby incorporated herein by reference.

### BACKGROUND

The need for color sensors is becoming more prevalent as technology moves away from black/white and gray scale imaging. Such color sensors are necessary for controlling display devices as well as for making color measurements. Many applications now exist where it is necessary to test a product for proper color. These situations range from determining that a proper yarn is being used to biomechanics where, for example, color is used to detect glucose levels.

Photodetectors, usually operating in conjunction with color filters, are now used to accomplish such color detection. Such photodetectors provide as their output signals (such as R, G and B) representative of the three basic colors (red, green and blue) which are electronically combined to produce color images.

Typically, the photo detector device specific RGB (or CMYK) outputs do not relate very well to the human eye's experience with color. Thus, in order to use the device specific color outputs for testing and control purposes it is necessary to convert them to a system that is device independent and universally accepted as being unambiguous. The profile connection space (PCS) is designed to accomplish this function. In the 1930s the Commission International de l'Eclairage (CIE) began to set color space standards in the form of models. Examples of these color space models are the CIELab, CIEXYX and the CIExyY models.

It is desired to convert device specific outputs (such as RGB and CMYK) to a PCS (commonly called standard) color space. However, before this can be accomplished it is critical to know the behavior of the photo detector device so that the ambiguous outputs from such a device can be converted to unambiguous color signal outputs. To do this, it has become accepted practice to use a color matching engine. The engine must know the device that generated the input signals (RGB or CMYK) and how those signals are going to be used, i.e. the target device. Accordingly, for each new device a calibration must take place and the necessary data stored for subsequent use.

### BRIEF SUMMARY OF THE INVENTION

In one embodiment of the invention there is disclosed a device for correcting the output of a light source such that the corrected output conforms to a known standard. The corrected light outputs are proportional to the colors contained in the light impacting the color sensor. In one embodiment, memory contains at least one color matching function pertaining to the specific color sensor and a controller works with the memory to convert the color sensor light outputs to a specific color PCS space based on the matching function. If desired, a user can select a desired PCS protocol.

In one embodiment, there is disclosed a method for calibrating a light sensor device by applying a light source to a light sensor with a known calibrated output and recording the calibrated outputs therefrom. The same light source is then applied to the light sensor device which has an uncalibrated output. The output from the uncalibrated light sensor is then recorded. After repeating these recordings for all of the pertinent color spectrum there is derived a CIE matching function for the uncalibrated light sensor by using the recorded outputs. This matching function is specific to the device and is used so that light subsequently applied to the uncalibrated light sensor will yield a calibrated output controlled, at least in part, by the stored matching function.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 shows one embodiment of the color sensor of the present invention;

FIG. 2 shows one embodiment of the color sensor of FIG. 1 used in a system for control purposes;

FIG. 3 shows an alternate embodiment of the light sensor of FIG. 1;

FIGS. 4, 5A and 5B show embodiments of calibration systems;

FIG. 6 shows an alternative embodiment for use with printed material;

FIGS. 7 and 8 show embodiments of calibration methods; and

FIGS. 9A, 9B, and 9C show embodiments of the prior art.

### DETAILED DESCRIPTION OF THE INVENTION

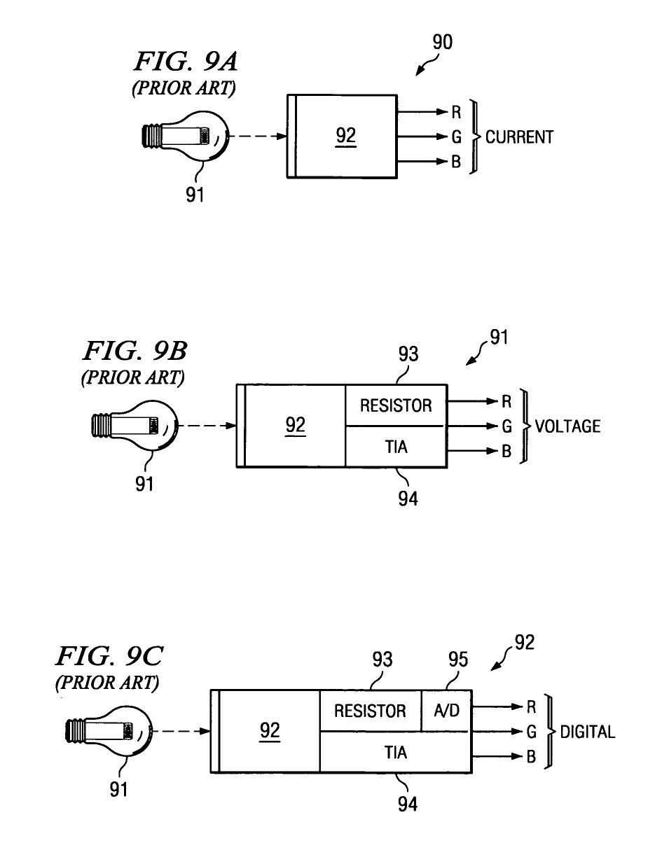

Prior to beginning a discussion of the inventive concepts, it would be helpful to briefly review the prior art with respect to FIGS. 9A, 9B and 9C.

FIG. 9A shows system 90 in which light source 91 impacts photo diode 92 with RGB producing photocurrent outputs.

FIG. 9B shows system 91 in which resistor 93 and a trans-impedance amplifier (TIA) 94 is used to convert the RGB current output (FIG. 9A) into an RGB analog voltage output.

FIG. 9C shows system 92 in which analog digital converter 95 has been added to convert the current output of FIG. 9B to an RGB digital output. Since these outputs are device-dependent and are representative of the input intensity of the various three colors depicted, they do not carry with them chromaticity or luminescence information. Thus, for systems which require chromaticity or luminescence information, the outputs of the devices shown in FIGS. 9A, 9B and 9C are not acceptable. Also, as discussed above, these signals do not translate well into the color spectrum that is observable by the human eye.

FIG. 1 shows one embodiment of color sensor 10 having input light 100 conveyed to color sensor 11. Voltage signals Vr, Vg, and Vb are output from color sensor 11 on lead 101 and form the input to analog to digital converter (ADC) 12 as discussed above with respect to FIG. 9C. The output of ADC 12 is a digital signal Vr, Vg and Vb on lead 102. This digital signal is input to controller 13. Controller 13 operates to accept the signals from lead 102 and perform an RGB to CIE conversion. This is accomplished by retrieving a CIE matching function from storage device 14. Various protocols can be used by controller 13, such as SPI 12c, etc. Storage device 14 can be any device that stores data and preferably would be an EEPROM. Selector input 105 can be provided so that a user can select a desired matching function, such as, for example, CIE LAB, CIE XYZ or CIE xyY. Color sensor 11 can be a set of photo diodes with filters so that each photo diode would output a voltage or current proportional to the amount of a certain frequency of light.

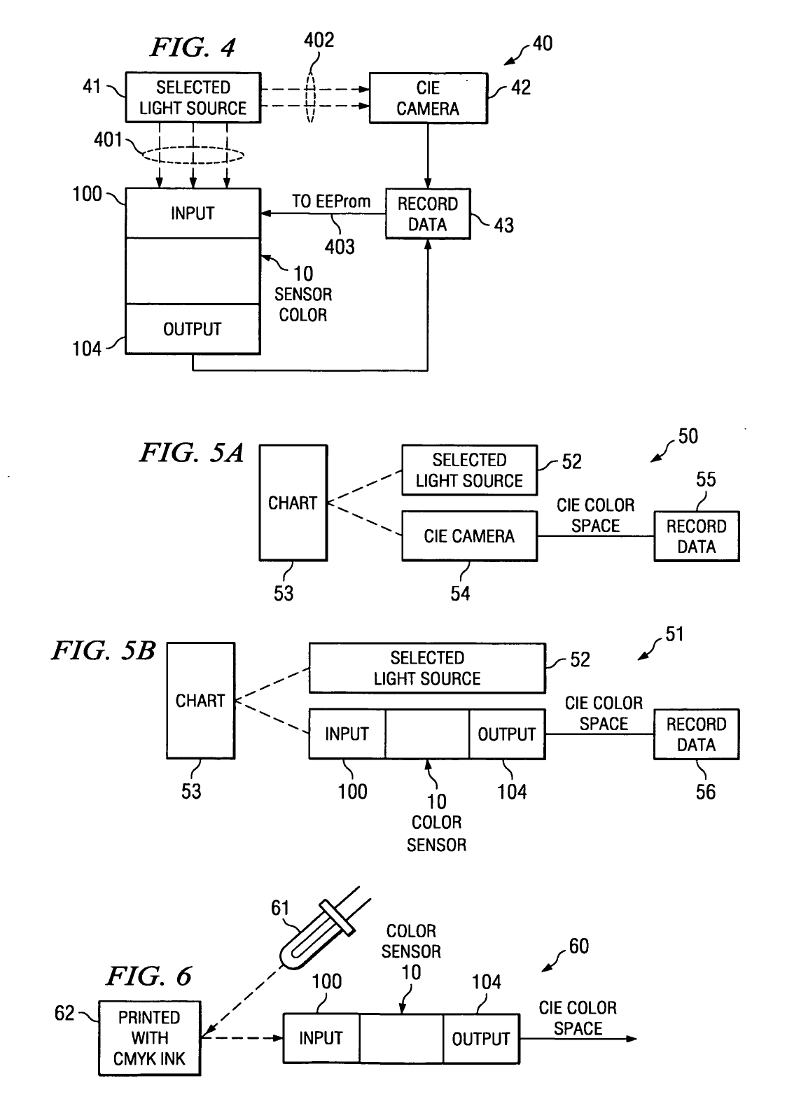

Storage 14 will confirm one or more pre-stored CIE matching functions, but prior to device 10 being calibrated, the output 104 for any light arriving at sensor 11 will be ambiguous. Calibration of device 10 will be discussed hereinafter with respect to FIGS. 4, 5A, 5B, 7 and 8. At this point it is sufficient to note that once a calibration has been performed on a specific device, the calibration need not be repeated unless a user has a reason to believe the device is out of calibration. If desired, the calibration can be performed periodically to ensure continued reliability.

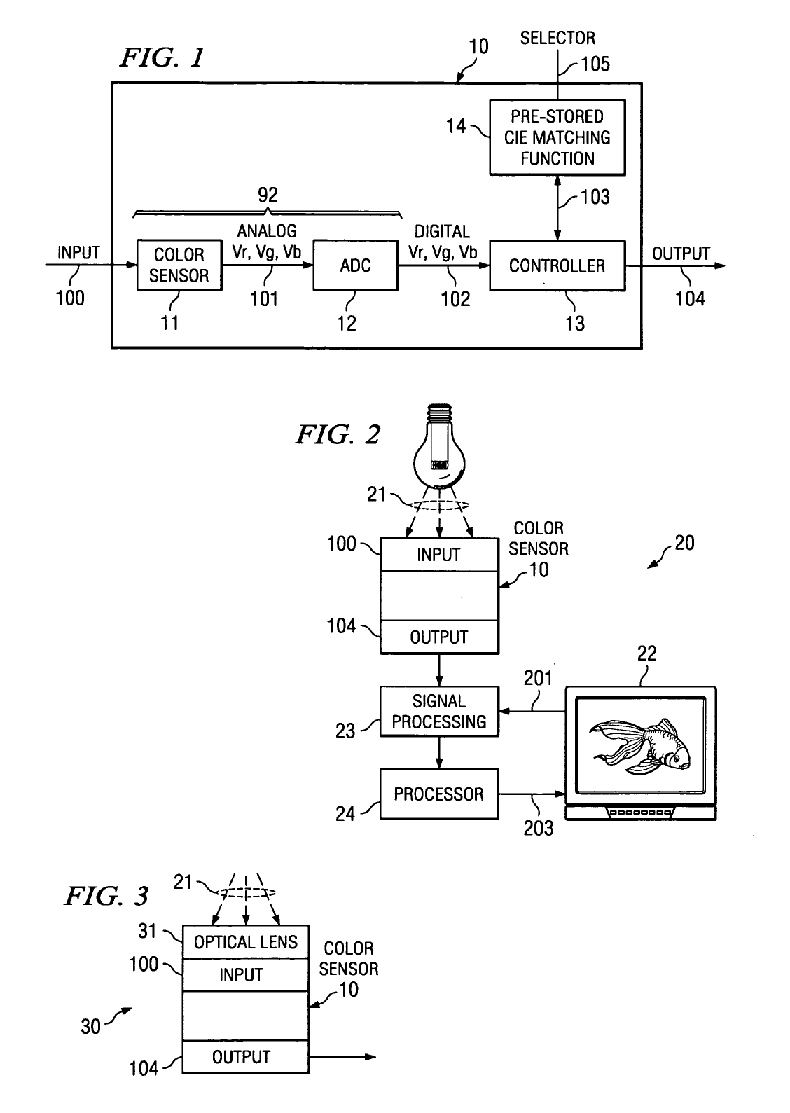

FIG. 2 shows one embodiment 20 of color sensor 10 used in a system for control purposes. Ambient light 21 impacts input 100 of device 10. Output 104 from device 10 is an unambiguous color space representation of the colors contained in ambient light 21 as discussed with respect to FIG. 1 (assuming device 10 has been calibrated). This color space representation of the ambient light is provided to controller 23 (in one embodiment, a signal processor) which receives inputs from display 22 via lead 201. The inputs from display 22 are compared and a signal is provided to processor 24 which uses the ambient chromaticity as well as brightness information as inputs and provides the information back to display 22 where display 22 can change its dynamic color and brightness under control of processor 24. This then allows display 22 (which could be a TV or other display device) to adjust its color balance based on the color spectrum of the ambient light. Note that, of course, signal processor 23 and processor 24 can be combined into one unit as well as this unit can also be combined with display 22. In one embodiment display 22 is a PDP display.

FIG. 3 shows an alternate embodiment 30 of light sensor 10 (FIG. 1) with optical lens 31 as part of input 100. Lens 31 functions to gather ambient light, such as ambient light 21 or any other light source into the input of device 10. Output 104 then, as discussed, provides unambiguous light output signals in the color space.

FIG. 4 illustrates an embodiment of a system and method for calibrating device 10 of FIG. 1. In operation, selected light from light source 41 is received by CIE camera 42. The light is measured therein and the outputs of the CIE camera, which by definition yield very accurate color space outputs, are used to code the output for a particular light input.

Light from source 41 is also provided to color sensor 10 and the outputs are recorded in storage 43. While a single database is shown, different or multiple databases can be utilized. The outputs from camera 42 are compared (frequency by frequency) against the outputs stored from color sensor 10 in order to derive a matching function. Once the matching function has been derived, this function is stored in device 10 via lead 403. Process 711 controls the storage of the function in EEPROM 14 within color sensor 10 via lead 403.

Note that the data recorded from CIE camera 42 is an unambiguous known entity and therefore the output from color sensor 10 which is ambiguous to begin with is then compared to the output of CIE camera 42 based upon the same light input from selected light source 41. The difference then over a broad spectrum is determined and becomes part of the matching function which is then stored in color sensor 10 (for example, in an EEPROM) so that in subsequent operations the output from color sensor 10 is corrected to be an accurate and unambiguous statement of the colors contained in a light source.

FIGS. 5A and 5B show a similar calibration system and method for reflective light. As shown in FIG. 5A, light source 52 reflects light from a chart, such as a MacBeth chart, into CIE camera 54 which records data in storage 55.

FIG. 5B shows light source 52 reflecting light from chart 53 into color sensor 10, the output of which is recorded in storage 56. The data in storage 55 is compared to the data in storage 56 to devise a proper matching function unique to device 10 and chart 53.

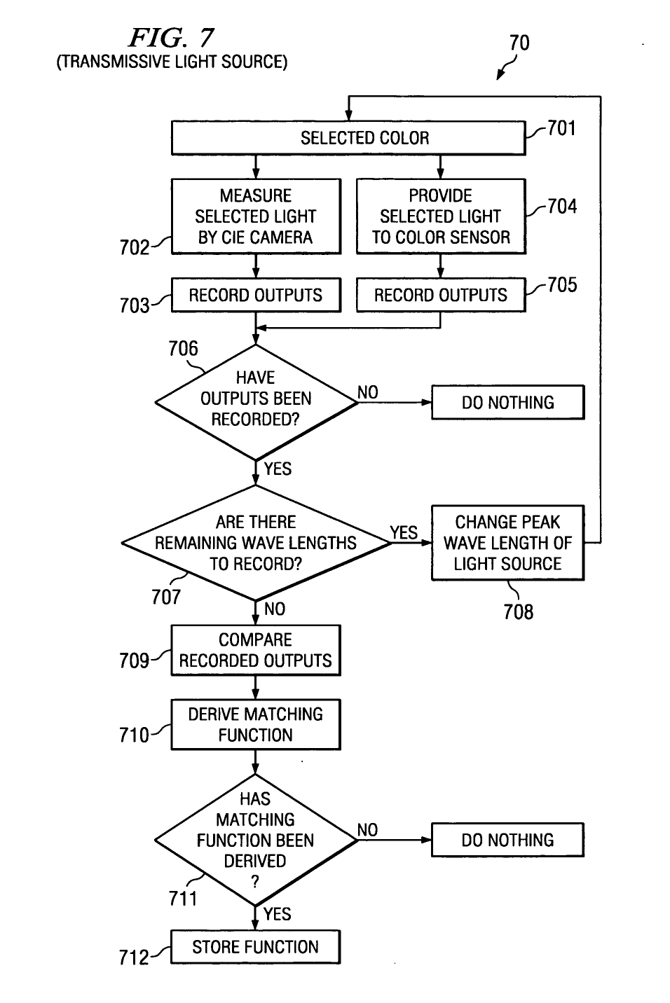

FIG. 6 shows alternative embodiment 10 for use with printed material which typically uses the CMYK color values. In the embodiment of FIG. 6, light source, such as LED 61, shines upon a material printed with CMYK ink. The reflection is then picked up by lens 100 of device 10 and output 104 is then converted into the CIE color space for presentation to a control system or for testing purposes, or to display the colors that are shown in the printed material on sheet 62.

FIG. 7 illustrates one embodiment 70 of a system and method for calibrating device 10. In operation, process 701 selects a color and process 702 or process 704 provides the selected color to both the camera (702) or the color sensor (704). The respective outputs are then stored, in processes 703 and 705. Process 706 determines if all the outputs have been recorded.

Since there could be several different light frequencies that need to be tested it is important to be sure they are each passed through the system for calibration and thus process 707 insures that all frequencies are tested. If some frequencies have not been tested, then process 708 changes the peak wavelength and process 70 repeats.

Once process 707 determines that there are no further wavelengths to record, process 709 controls the comparison of the recorded outputs from both the CIE camera and the color sensor in order to derive a matching function under process 710. Once the matching function has been derived, process 711 and process 712 control the storage of the function, for example, in an EEPROM within device 10.

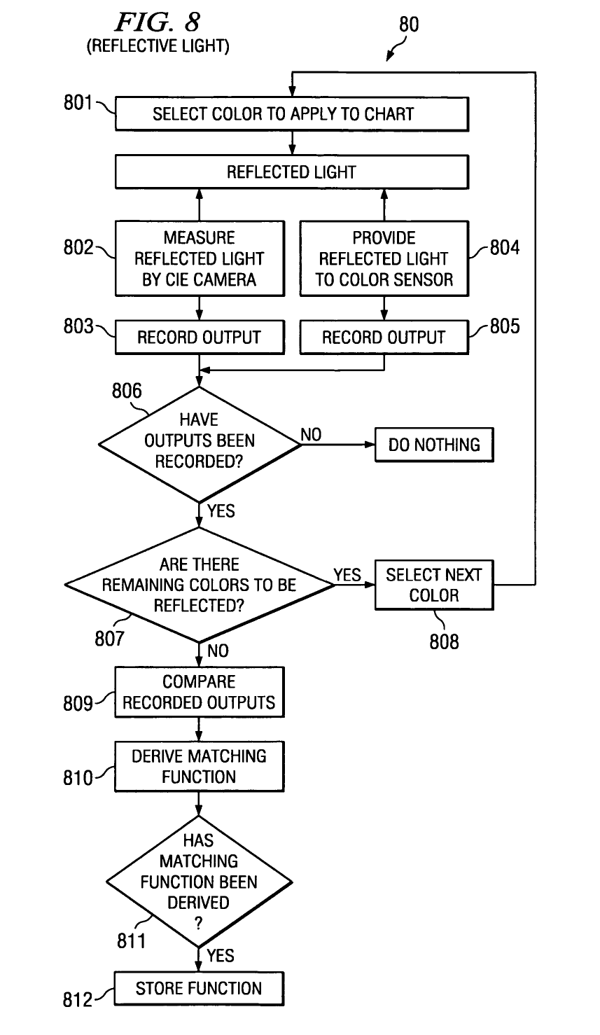

FIG. 8 shows process 80 for selecting a light frequency to be corrected using a reflective light system. In operation, process 801 selects a color to apply to the chart and process 802 or process 804 provides the light either to the CIE camera or to the color sensor. This can be done sequentially or in parallel. The outputs are recorded by either process 803 or 805. Processes 806-812 are the same as discussed with respect to FIG. 7 process 706-712. The difference being that when a chart is being used there are certain colors in the chart that must be cycled through. This is controlled by process 807. For example, with the MacBeth chart, there are 24 colors which would be cycled in order to achieve the proper matching function.

The matching function is derived in many ways, one of which is a n×3 matrix containing XYZ outputs, for example, from the CIE camera which equals a coefficient times three×n matrix containing RGB outputs from the light sensor. The CIE matching function is derived by solving the linearly correlated equation.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A device for providing color space outputs, said device comprising:
means for receiving light; and
means based at least in part on a pre-stored device dependent matching function for mapping received light into a digitized standard color space.

2. The device of claim 1 wherein said mapping means comprises:
means for converting said received light into digital RGB outputs; and
means, based at least in part on a pre-stored device dependent matching function, for mapping said digital RGB outputs into said digitized standard color space.

3. The device of claim 2 wherein said converting means further comprises:
means for storing at least one CIE matching function.

4. The device of claim 3 wherein said standard color space is selected from one of the following: CIE xyY, CIELab, CIE XYZ.

5. The device of claim 3 wherein said storing means comprises a non-volatile memory.

6. The device of claim 5 wherein said memory is an EEPROM.

7. The device of claim 2 wherein said converting means comprises:
means for first converting said received light into RGB analog voltages; and
means for converting said RGB analog voltages to said digital RGB outputs.

8. The device of claim 1 wherein said light receiving means comprises: at least one optical lens.

9. The device of claim 1 further comprising:
means for selecting a particular color space.

10. A method for calibrating a light sensor, said method comprising:
applying a light source to a light sensor with a known calibrated output, said output being values in the color space;
recording the calibrated outputs from said applied light;
applying said light source to a light sensor having an uncalibrated output;
recording the uncalibrated outputs from said applied light;
repeating said applying and recording until several light frequencies of said light have been applied to both said sensors;
deriving a CIE matching function for said uncalibrated light sensor by using said recorded outputs; and
storing said derived matching function in a memory permanently associated with said uncalibrated light sensor, such that light subsequently applied to said uncalibrated light source will yield a calibrated output controlled, at least in part by said stored matching function.

11. The method of claim 10 wherein said deriving comprises:
solving linearly correlated equations by using said matching function.

12. A light sensor comprising:
a color sensor for providing outputs proportional to certain colors contained in light impacting said color sensor;
a memory for storing color matching functions pertaining to said color sensor; and
a controller for converting provided ones of said outputs into a specific color space based on a matching function stored in said memory.

13. The light sensor of claim 12 further comprising:
an input for receiving instructions for adjusting said matching function.

14. The light sensor of claim 12 further comprising:
optics for modifying said light impacting said sensor.

15. The light sensor of claim 12 wherein said color space is selected from the list of CIE XYZ, CIE XyY, CIELab.

16. A system for color control, said system comprising:
a light sensor for accepting ambient light; and
a display susceptible to being impacted by said ambient light;
a controller for said display, said controller operable for adjusting the color space values of said ambient light and for providing control signals to said display based on said adjusted value such that said display can adjust its color parameters in accordance with said accepted ambient light.

17. The system of claim 16 wherein said controller comprises:
a pre-stored matching function specific to said light sensor.

18. The system of claim 16 wherein said display comprises:
a color camera; and wherein said controller is further operable to correct images formed by said camera based on ambient light impacting said camera.

19. The system of claim 16 further comprising:
an optical lens positioned between said ambient light and said light sensor.

20. The system of claim 16 wherein said ambient light is light reflected from a surface.
